(19) United States
(12) Patent Application Publication
(10) Pub. No.: US 2018/0239083 A1
(43) Pub. Date: Aug. 23, 2018

(54) BI-DIRECTIONAL PUMP LIGHT FIBER FOR ENERGY TRANSFER TO A CLADDING PUMPED FIBER

(71) Applicant: Hong Po, Sherborn, MA (US)

(72) Inventor: Hong Po, Sherborn, MA (US)

(21) Appl. No.: 15/751,604

(22) PCT Filed: Aug. 12, 2016
(86) PCT No.: PCT/US16/46902

§ 371 Date: Feb. 9, 2018

Related U.S. Application Data
(60) Provisional application No. 62/204,143, filed on Aug. 12, 2015.

(51) Int. Cl. G02B 6/028; H01S 3/094; H01S 3/067

(52) U.S. Cl. CPC G02B 6/0288; H01S 3/094007; H01S 3/094053; H01S 3/06716; H01S 3/094011; H01S 3/094019

(57) ABSTRACT

An X-junction side coupler is formed by the attachment of a clad stripped special pump fiber to a section of the cladding pumped fiber with its outer cladding removed. The special formulated core of the pump fiber has a lower refractive index than the inner cladding of the cladding pumped fiber, and the resulting composite structure forms an anti-guide for the pump light. Due to the differential refractive index at the interface of the two guides leaky modes are generated to strip away the pump light efficiently and irreversibly from the pump guide to the cladding pumped fiber. An appropriate coupling length will ensure pump light injected in one end will not interfere with the source at the opposite end thus allowing bi-directional pumping in each coupling site. This new device invention facilitates the implementation of distributed pump architecture for cladding pumped fiber devices enabling very high power scaling with good thermal management control.

### STATEMENT REGARDING FEDERALLY SPONSORED RESEARCH OR DEVELOPMENT

(Not Applicable)

### INTRODUCTION

Side coupling of pump light into cladding pumped fiber devices such as amplifiers and lasers is disclosed. Specifically, a pump guide of lower refractive index with respect to the inner cladding of a cladding pumped fiber is used to effect a non-reciprocal transfer of power. The pump guide can be implemented in a distributed pumping fiber laser and amplifier architecture for power scaling.

Since its invention in the 1980s, see, e.g., U.S. Pat. No. 4,815,079 entitled “Optical Fiber Lasers and Amplifiers,” cladding pumped fiber devices such as amplifiers and lasers found prolific applications in optical communication networks, printing, medical treatments and industrial material processing. A cladding pumped fiber structure typically consists of a smaller core, a larger diameter inner cladding and an outer cladding layer. The core is doped with, among other elements, rare earth ions which provide gain when activated, and has a raised refractive index from the surrounding inner cladding. The inner cladding mostly made of fused silica in turn is enclosed by an outer cladding layer made of low index polymer thus forming a multimode guide for the pump light. When an appropriate wavelength pump light is injected into the inner cladding multimode waveguide, the pump power is absorbed by the rare earth ions as the light propagates through the guide crisscrossing the doped core. Thus the activation of the core provides gain for the length of the active fiber. It becomes a laser if both ends of the cladding pumped fiber have optical feedback, alternatively if optical feedback is suppressed it becomes an amplifier. The various geometrical shaped designs of the cladding-pumped fiber are mainly aimed at improving the absorption efficiency of the pump light. The above described cladding pumped fiber is known as the solid type. An alternate type known as photonic crystal cladding pumped fiber has a structure whose central area is doped with rare earth but its refractive index matches with the intermediate medium of fused silica. A two dimensional array pattern of holes, either air or lower refractive index medium filled, serves as the inner cladding whose targeted average refractive index is slightly lower than the doped core region. The outer cladding can be either made of low index polymer or series air holes with thin membrane bridges.

The remarkable advantage of the cladding pumped fiber devices is its ability to convert light from low cost low brightness high power semi-conductor laser diodes into high brightness high power high quality beam lasers or amplifiers.

Various forms of fiber side couplers have been used to couple pump light to the cladding pumped fiber devices. U.S. Pat. No. 5,864,644 de-scribes a side coupler utilizing a taper fiber bundle consists of a signal carrying fiber in the center surrounded by six multimode pump guides. U.S. Pat. No. 5,999,673 advocates the use of a tapered section of the feed fiber wrapped around the cladding-pumped fiber. U.S. Pat. No. 6,826,335 B1 espouses a composite structure of two fibers in optical contact surrounded by a common low index polymer coating; one of the fibers is the cladding pumped fiber while the other is the pump fiber. Pat. No. WO 2010057288 A1 promotes the deployment of multi-clad waveguide structure to facilitate side coupling of pump light.

All the above cited fiber side couplers have in common that their interface has a perfect match refractive index, consequently light can easily flow from the pump fiber into the cladding pumped fiber and vice-versa thus the reciprocity law of optics holds. Therefore at each injection point only the Y-junction type side coupler can work efficiently, it is unidirectional by nature. The Y-type coupler is either forward directed or backward directed along the cladding pumped fiber. With such Y-type side couplers counter pumping can only be implemented by a single or clusters of Y-couplers at both ends of the fiber device.

Aggravating the problem is that most of the couplers need to have the passive signal core mode matched and aligned before butt-spliced to the active core of the cladding pumped fiber. In high power fiber de-vices butt-splices should be avoided or minimized because the inadvertent splice loss causes serious heating problems. Another disadvantage of the Y-type side coupler, because the potential reverse flow of pump light, it is impractical to implement the distributed pumping scheme, hence the mitigation of heating effect becomes difficult.

Some attempts to overcome these problems by using tandem pumping or multi-clad fiber structures render the overall cladding pumped fiber devices more costly.

### SUMMARY

In accordance with the invention, pump light is coupled into the cladding pumped fiber via X-junction type side coupler using a pump guide that has its core refractive index lower than that of the inner cladding of the cladding pumped fiber. At the contact interface of the two naked fibers leaky modes are generated to transfer pump power efficiently and irreversibly from the pump guide to the multimode inner clad guide. With sequential cross section reduction of the pump guide the attachment length can be short and compact before all the pump light is extracted from the pump guide. For each attachment pump light can be injected in both ends of the pump fiber of the X-junction side coupler forming a unique bidirectional pumping device. Multiple pump fibers can be simultaneously attached to the cladding pumped fibers, of the solid or photonic crystal type, at each injection site.

The advantage of bi-directional coupling plus the easy fabrication makes it ideal to be deployed in the distributed pumping scheme where pump light is injected at periodic sites along the length of the cladding pumped fiber devices for the purposes of heating effect mitigation and power scaling.

According to an example, an optical fiber device for transferring pump energy to a cladding pumped optical fiber is provided that includes a pump light guide communicatively coupled to the cladding pumped fiber so as to permit light from the pump light guide to be received by the cladding pumped fiber, the pump light guide being configured with a lower refractive index than the cladding pumped fiber and the pump light guide being configured with a number of injection sites, each site being suitable for injection of pump light to be received by the cladding pumped fiber.

The optical fiber device may be provided with an optical interface between the pump light guide and the cladding pumped fiber where they are coupled, where the pump light guide is configured to generate leaky modes upon the injection of pump light, such that a majority of pump light crosses the interface from the pump light guide to the cladding pumped fiber. The pump light guide may be configured with a reduced area cross-section near the optical interface, which may be configured to avoid coupling loss. The pump light guide may operate as a light anti-guide at the optical interface, and may be configured with a numerical aperture in a range of from about −0.01 to about −0.40 with respect to the cladding pumped fiber. The pump light guide may include a long axis that is non-parallel with a long axis of the cladding pumped fiber, and may be coiled around the cladding pumped fiber.

The pump light guide coupling to the cladding pumped fiber may be in the form of an X-junction side coupler and may be composed of silica doped with one or more elements of fluorine or boron. The pump light guide may be configured to provide bidirectional pumping to the cladding pumped fiber. A set of pump light guides may be communicatively coupled to the cladding pumped fiber at a single injection site so as to permit light from the set of pump light guides to be received by the cladding pumped fiber. The set of pump light guides may be coiled around the cladding pumped fiber. Each one of the pump light guides in the set may be communicatively coupled to the cladding pumped fiber at a different, distinct injection site so as to distribute light from the set of pump light guides along the cladding pumped fiber.

According to an example implementation, a method for transferring energy to a cladding pumped fiber is provided, where the method includes configuring a pump light guide with a lower refractive index than the cladding pumped fiber, communicatively coupling the pump light guide to the cladding pumped fiber so as to permit light from the pump light guide to be received by the cladding pumped fiber and injecting pump light into the pump light guide to be received by the cladding pumped fiber. The method may include generating leaky modes in the pump light of the pump light guide to cause a majority, or substantially all, of the pump light to be received by the cladding pumped fiber. The method may include reducing a cross sectional area of the pump light guide to avoid coupling loss near an injection site where the pump light guide and the cladding pumped fiber are communicatively coupled.

According to another example, a method for injecting pump light into an optical light guide is provided, where the method includes coupling a pump light guide with a lower refractive index than the optical light guide to the optical light guide and injecting light to the pump light guide from two different sides of where the pump light guide and the optical light guide are coupled, such that bidirectional light from the pump light guide is entirely transferred to the optical light guide. The method may further include configuring the pump light guide as a pump light isolator.

The presently described side pump coupler can transfer pump power efficiently yet irreversibly from the pump guide to the cladding pumped fiber. The pump guide can be configured as an X-junction structure making possible a bi-directional pump light coupling at each injection point. The pump guide can be easily attached to the most common cladding pumped fibers without the need of butt splices.

### BRIEF DESCRIPTION OF THE SEVERAL VIEWS OF THE DRAWINGS

The advantages and special features of the novel side coupler become apparent in the illustrative embodiment of the invention that is now described in detail with reference with the following drawings, where:

FIG. 1 shows schematically a basic arrangement of using an X-junction for coupling pump light into a cladding pumped fiber;

FIGS. 2a-2b illustrate a cross section of two fibers attached to each other and the refractive index profile of the resulting composite structure;

FIG. 3 depicts an alternate embodiment of an attachment in a coiled form whereby the pump fiber is coiled around the cladding pumped fiber;

FIG. 4 shows multiple pump fibers attached to a cladding pumped fiber at an injection site;

FIG. 5 illustrates the cross sections of six pump fibers attached to a cladding pumped fiber in one location site;

FIG. 6 shows schematically the arrangement of bidirectional pumping via an X-junction side coupler;

FIG. 7 demonstrates how directionally coupling can be deployed in interval distances along the cladding pumped fiber; and

FIG. 8a-8d are the plots of results of a computer model of a distributed pumping scheme for high power fiber laser.

### DETAILED DESCRIPTION

The entire disclosure of U.S. Provisional Patent Application No. 62/204,143, Filed Aug. 12, 2015, entitled “BI-DIRECTIONAL PUMP LIGHT FIBER SIDE COUPLING DEVICES USING LEAKY MODES FOR IRREVERSIBLE ENERGY TRANSFER BETWEEN THE PUMP GUIDE AND THE CLADDING PUMPED FIBER” is hereby incorporated herein by reference.

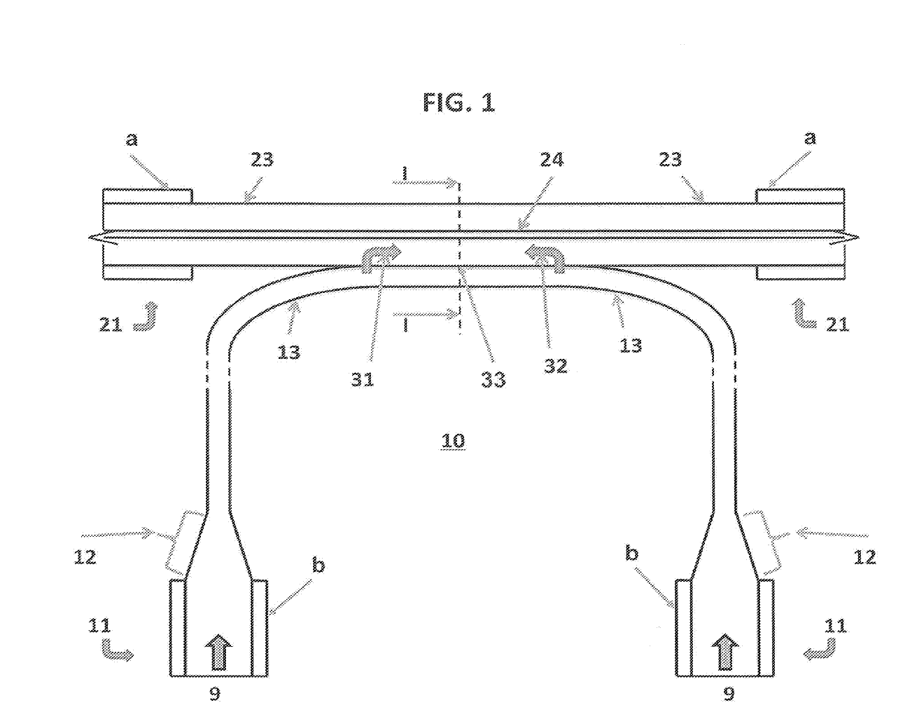

With reference to the drawings, FIG. 1 shows the arrangement of the X-junction side coupler. The fiber 21 comprises outer cladding “a”, inner cladding 23 and lasing core fiber 24. A section of the cladding pumped (CP) fiber 21 has its lower refractive index polymer outer cladding removed exposing its fused silica inner cladding multimode waveguide fiber 23 for the attachment of the treated pump fiber. The pump fiber 11 has a polymer coating for convenient stripping and a solid core consisting of fluorine doped silica, or other dopants such as boron, that renders its refractive index lower than the silica inner cladding of the CP fiber 21. When compared to fused silica the so called fluorine down-doped pump fiber core 13 can have a negative numerical aperture (NA) ranging from about −0.01 to about −0.40, and more particularly, from about −0.10 to about −0.26. This special pump fiber is customized with core diameter and NA that match the typical commercial all glass pigtail multimode fibers of 200 μm and NA of 0.22 or 105 μm and NA of 0.15 so that it can be fuse spliced to the existing pigtailed pump modules or can replace the conventional pigtail fibers in the pump modules.

Before the attachment, a length of the pump fiber 11 has its polymer cladding stripped then tapered down as shown by fiber section 12 and its diameter reduced to the diameter as shown at 13 by specialized thermal equipment, e.g. a fuse taper machine. The reduction in area of the stripped pump fiber for minimum loss should be governed by the conservation of the etendue G (geometric etendue G is the product of area×solid angle). The brightness of a light source is defined by 8=Power/[area×solid angle] or Power/etendue, hence the conservation of brightness is equivalent to conservation of etendue. For minimum loss the final (reduced diameter) etendue should be equal or greater than the initial etendue. As an example, let the initial pump fiber 11 of 200 μm and NA of 0.22 has area A1, and the reduced or necked down fiber 13 has area A2 and NA of −1.0 (air clad); by the conservation law A1*(0.22)²=A2*(1.0)² and so the final reduced diameter of the stripped pump fiber 13 should equal or greater than 44 μm. The reduced diameter pump fiber 13 is then attached or fused to CP fiber 23 as shown in FIG. 1, to form an X-junction side coupler. Pump light is injected to port 9 at both ends of the pump fiber 11. At the attachment interface 33 leaky modes are generated to couple pump light into the inner clad guide of CP fiber. As the power attenuates exponentially in the pump fiber 13, with a proper attachment (coupling) length all the light can be extracted away, and therefore pump light can be injected simultaneously in both directions, forward and backward as indicated by the curved arrows 31-32 without feedback interference to the pump sources.

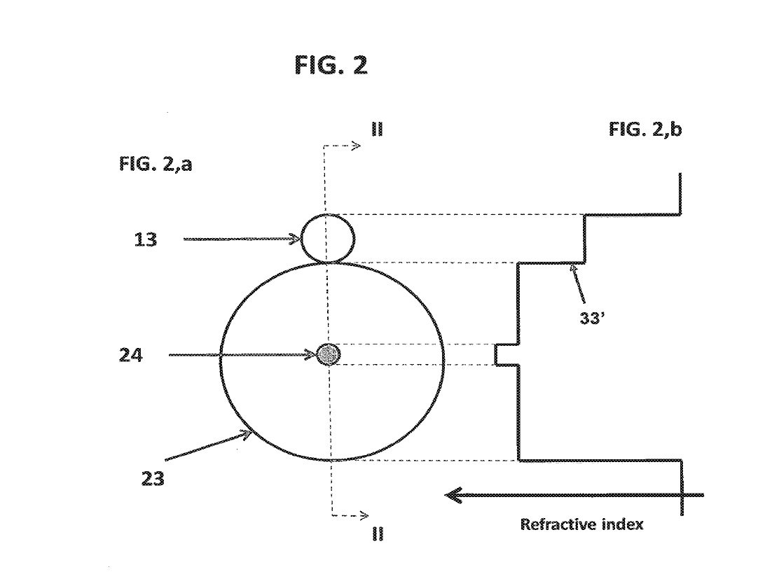

FIG. 2 is the cross sectional view in the middle of the attachment position 33, shown by a dashed line of the plane I in FIG. 1, the pump fiber 13 is attached or fused to inner cladding fiber 23 with a doped core 24. The diagram shows a round CP fiber 23 for simplicity, it is well understood by the practitioners of the art for effective mode scrambling to enhance pump absorption in the core other geometric shapes, octagonal, hexagonal, rectangular, square, D-shape rather than round are more commonly deployed, hence the embodiment is not limited to a single geometric shape. A vertical dotted line II drawn though the centers of fibers 13 and 23 maps out the refractive index profile in FIG. 2b of the composite structure. The core 24 has a slight raised step index from the silica inner cladding 23, and most of the perimeter of fiber 23 is surrounded by air which has an index of 1.0; at the contact interface 33 the refractive index goes through a sharp drop 33′ from fused silica to the fluorine down-doped silica core of the pump fiber 13; beyond the contact interface pump fiber 13 is surrounded by air. Beyond the attachment region fiber 13 is a perfect waveguide with light well confined in the core, but in the attachment region because of the new boundary conditions it becomes an anti-guide setting up leaky modes that quickly cause exponential attenuation of the pump light which channels laterally and irreversibly into the multimode fiber 23.

A simplistic but valid explanation of mode power behavior at the interface of two bounded lossless dielectric media have three possible outcomes (Ref. 1; Jonathan Hu and Curtis R. Menyuk, “Understanding leaky modes: slab waveguide revisited”, Advances in Optics and Photonics 1, 58-106 (2009) doi: 1O.1364/AOP.1.000058) depending on the refractive indices. Let the plane of interface be parallel to direction of propagation, and the x-axis is perpendicular to the interface plane; If 1) n1>n2, the light carrying medium n1 has higher index than the adjacent medium n2, the boundary solution sets up an E-field given by the expression Aexp(−αx) which is the evanescent field into the adjacent area, and the modes are well guided; 2) n1=n2, two media have perfect matched indices, the solution becomes Aexp(ikₓx)+Bexp(−ikₓx) which are the forward and backward traveling waves, resulting in the radiation modes; 3) n1<n2. the given expression is Aexp(−ikₓx) where kₓ, is a complex number representing leaky modes with peculiar phenomena of amplitudes increasing away from the boundary. As the amplitude grows laterally by the conservation of flux, a commensurate power decays in the propagation direction. The lateral transfer of light by the anti-guide structure is irreversible because light once captured into fiber 23 encounters a reversed boundary condition of 1) n1>n2 and so is well confined as guided modes that cannot escape. Accordingly, at the attachment region, fiber 13 acts as a pump light isolator, since all of the energy is transferred to the adjacent media due to the leaky modes, and the pump light does not return to the pump guide, but rather is confined in the adjacent media due at least in part to the reversed boundary condition.

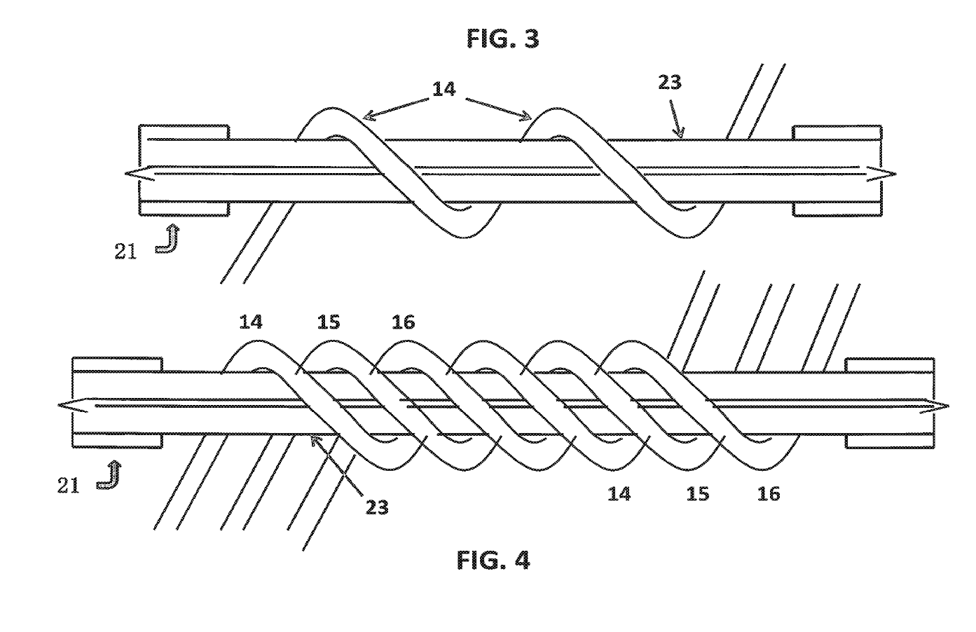

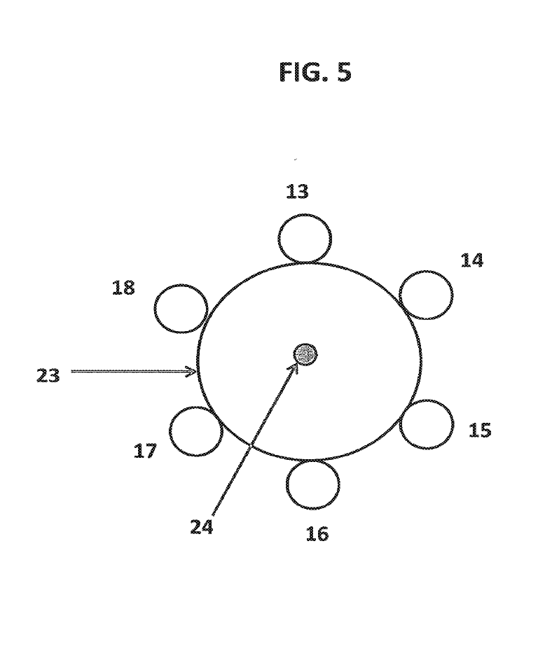

FIG. 3 depicts a modified embodiment of the attachment of the pump fiber by coiling it around the CP fiber 23 as pump fiber 14. Coiling induces microbending stresses that serves as a mode scrambler to convert the lower order modes into higher orders for more efficient cross coupling at the same time it increases the attachment length for effective total transfer of pump light and yet it produces a compact form for efficient packaging. The cross coupling efficiency in terms of shorter coupling length can be further enhanced by sequential cross sectional reduction of pump fiber 13 when in the form of fiber 14. For example, the cross sectional reduction can be from 44 to 10 and then to 2.5 μm. Increase in pump power at the injection site can be easily accomplished by multiple, in this case 3 as indicated in FIG. 4, pump fibers 14, 15, 16 coiled around and attached to the CP fiber 23. The cross section of the attachment of six pump fibers, 13, 14, 15, 16, 17, 18, around the CP fiber 23 with active core 24 is illustrated in FIG. 5. It is apparent that more pump fibers translate to more pump power, therefore it begs the question that for a given CP fiber how many pump fibers are permissible to attach without violating the brightness law? Let the area of CP fiber=Aᵢ and its NAᵢ=0.46; the area of feed fiber=A_{f} and its NA_{f}=0.22, and the number of feed fibers be n. For minimum loss the etendue of the target should be=/>than the sum total of the sources. The target etendue Gt is the etendue of the CP fiber 23 is given by Gₜ=Aᵢ×NAᵢ² and G_{f} is the etendue of each feed fiber is given by G_{f}=A_{f}×NA_{f}², therefore by applying the equivalent conservation of etendue theorem Gt=n×G_{f} or n=Gₜ/G_{f}. If we take the CP fiber of 250 μm and the pump fiber of 200 μm, the optimum target etendue Gt=6.8 G_{f}, hence for minimum loss the number n of feed fibers should be 6.

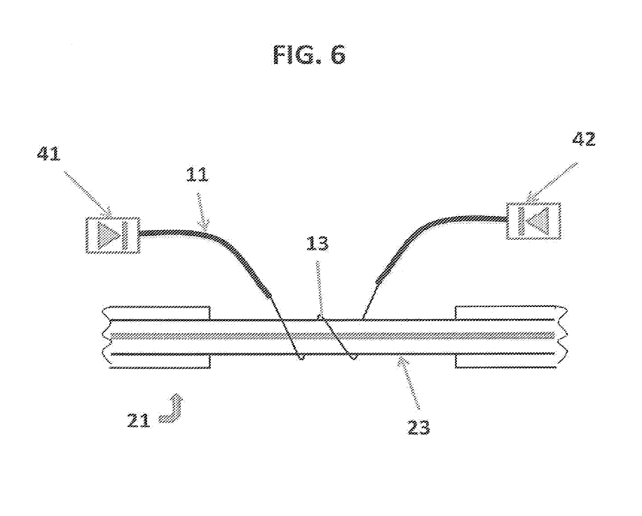

FIG. 6 depicts the arrangement of the bi-directional pumping of the CP fiber in an embodiment of the invention; the outer cladding of a section of the CP fiber 21 is stripped so that the reduced cross section pump fiber 13 can be coiled and attached to fiber cladding 23 forming an X-junction side coupler. Pump modules 41, 42 inject pump light into both ends of pump fiber 11 for forward and backward pumping of the CP fiber.

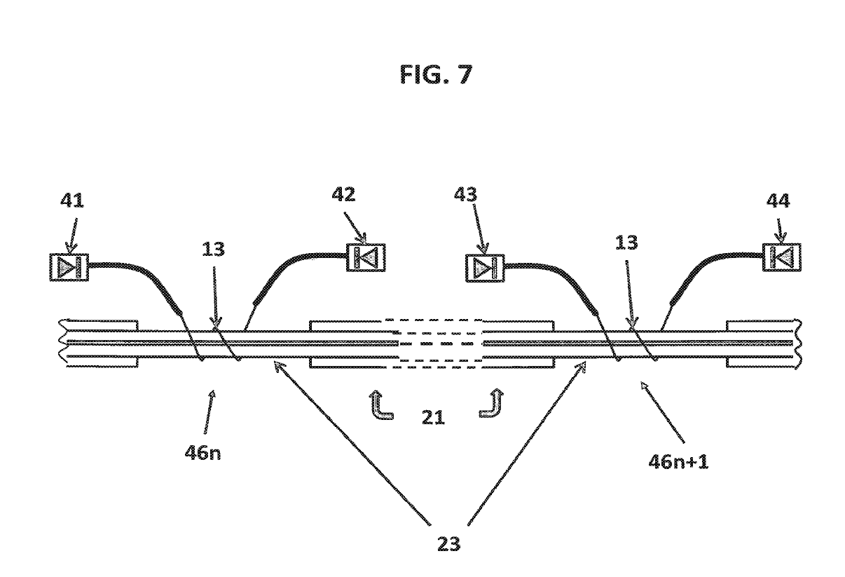

The schematic of the distributed pumping arrangement for CP fiber devices is shown in FIG. 7. At each injection site 46 n, n+1, etc. pump light is coupled bi-directionally into the CP fiber. Though the diagram shows a single pump fiber attachment, multiple pump fibers, as illustrated above, could be easily deployed at each injection site, and the injection sites are distributed along the CP fiber device. The detail arrangement and its advantages will be described in the following figure.

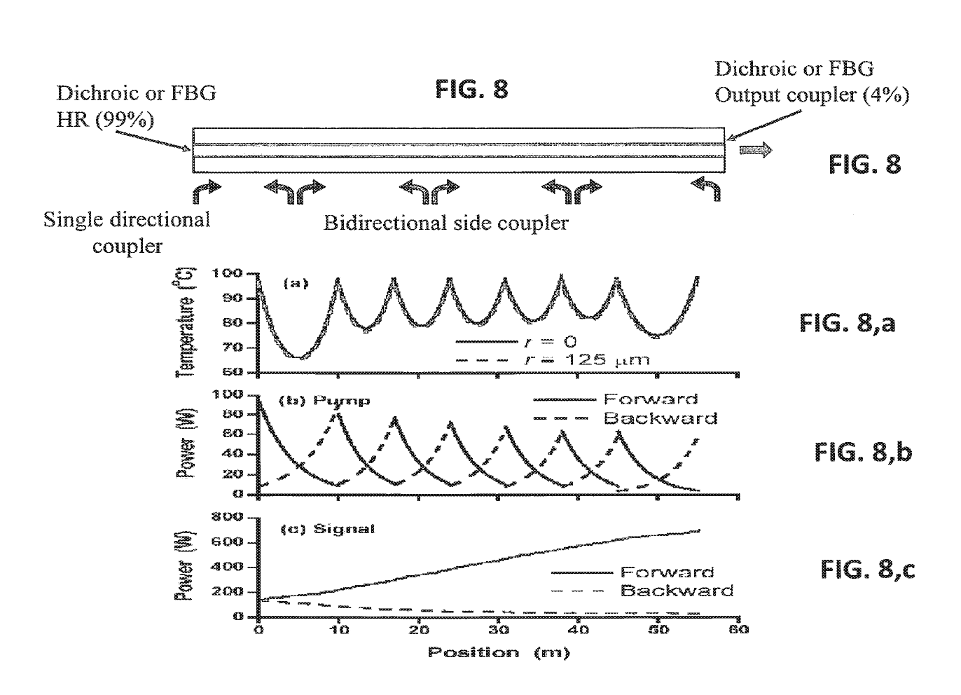

FIG. 8 (Ref. 2; Y. Wang, c.o. Xu, and H. Po, “Pump Arrangement for Kilowatt Fiber Lasers”, invited paper, IEEE LEOS 2003, Oct. 27, 2003, Tucson, Ariz.); FIG. 8a-8c are plots of computer models of a distributed pump scheme for a high power cladding pumped fiber device, fiber laser. A high reflectance feedback mechanism, dichroic mirror or fiber Bragg grating, is fixed on the left end of the CP fiber, while a low reflectance mechanism serving as the output coupler is placed on the opposite end. A single directional side coupler is attached on both ends for forward and backward pumping and bidirectional side couplers are placed periodically along the CP fiber device as shown in the sketch. The clear advantage of the distributed pump scheme becomes apparent in plot FIG. 8a where the profile of the temperature, i.e. heat load, is distributed quite evenly throughout the fiber laser. This is clear departure from conventional end pump schemes where severe detrimental thermal loading occurs at the ends. Excessive heating can cause degradation of the low index polymer coating thus poses reliability problems for the fiber laser. Furthermore the distributed pumping gives the flexibility of adjustment, plot FIG. 8b, of pump power profile, hence the temperature profile, to possibly mitigate some harmful nonlinear effects such as stimulated Brillouin scattering. Finally FIG. 8,c shows the laser power, in both forward and backward directions inside the CP fiber.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known processes, structures, and techniques have been shown without unnecessary detail to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process that is depicted as a flow diagram or block diagram. Although each may describe the operations as a sequential process, many of the operations can be performed in parallel or concurrently. In addition, the order of the operations may be rearranged. A process may have additional stages or functions not included in the figure.

Having described several example configurations, various modifications, alternative constructions, and equivalents may be used without departing from the scope of the disclosure. For example, the above elements may be components of a larger system, wherein other structures or processes may take precedence over or otherwise modify the application of the invention. Also, a number of operations may be undertaken before, during, or after the above elements are considered. Accordingly, the above description does not bound the scope of the claims.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

What is claimed is:

1. An optical fiber device for transferring pump energy to a cladding pumped optical fiber, comprising:
a pump light guide communicatively coupled to the cladding pumped fiber so as to permit light from the pump light guide to be received by the cladding pumped fiber;
the pump light guide being configured with a lower refractive index than the cladding pumped fiber; and
the pump light guide being configured with a plurality of injection sites, each site being suitable for injection of pump light to be received by the cladding pumped fiber.

2. The optical fiber device according to claim 1, further comprising:
an optical interface between the pump light guide and the cladding pumped fiber where they are coupled;
the pump light guide being configured to generate leaky modes upon the injection of pump light, such that a majority of pump light crosses the interface from the pump light guide to the cladding pumped fiber.

3. The optical fiber device according to claim 2, further comprising the pump light guide being configured with a reduced area cross-section near the optical interface.

4. The optical fiber device according to claim 3, further comprising the reduced area cross-section being configured to avoid coupling loss.

5. The optical fiber device according to claim 2, wherein the pump light guide further comprises a light anti-guide at the optical interface.

6. The optical fiber device according to claim 1, further comprising the pump light guide being configured with respect to the cladding pumped fiber with a numerical aperture in a range of from about −0.01 to about −0.40.

7. The optical fiber device according to claim 1, further comprising the pump light guide including a long axis that is non-parallel with a long axis of the cladding pumped fiber.

8. The optical fiber device according to claim 7, further comprising the pump light guide being coiled around the cladding pumped fiber.

9. The optical fiber device according to claim 1, wherein the pump light guide coupled to the cladding pumped fiber comprises an X-junction side coupler.

10. The optical fiber device according to claim 1, wherein the pump light guide further comprises silica doped with one or more elements of fluorine or boron.

11. The optical fiber device according to claim 1, further comprising the pump light guide being configured to provide bidirectional pumping to the cladding pumped fiber.

12. The optical fiber device according to claim 1, further comprising a plurality of pump light guides communicatively coupled to the cladding pumped fiber at a single injection site so as to permit light from the plurality of pump light guides to be received by the cladding pumped fiber.

13. The optical fiber device according to claim 12, further comprising the plurality of pump light guides being coiled around the cladding pumped fiber.

14. The optical fiber device according to claim 1, further comprising a plurality of pump light guides, each one in the plurality being communicatively coupled to the cladding pumped fiber at a different, distinct injection site so as to distribute light from the plurality of pump light guides along the cladding pumped fiber.

15. A method for transferring energy to a cladding pumped fiber, comprising:
configuring a pump light guide with a lower refractive index than the cladding pumped fiber;
communicatively coupling the pump light guide to the cladding pumped fiber so as to permit light from the pump light guide to be received by the cladding pumped fiber; and
injecting pump light into the pump light guide to be received by the cladding pumped fiber.

16. The method according to claim 15, further comprising generating leaky modes in the pump light of the pump light guide to cause a majority of the pump light to be received by the cladding pumped fiber.

17. The method according to claim 15, further comprising reducing a cross sectional area of the pump light guide to avoid coupling loss near an injection site where the pump light guide and the cladding pumped fiber are communicatively coupled.

18. The method according to claim 15, further comprising doping the pump light guide with one or more elements of fluorine or boron.

19. A method for injecting pump light into an optical light guide, comprising:
coupling a pump light guide with a lower refractive index than the optical light guide to the optical light guide; and
injecting light to the pump light guide from two different sides of where the pump light guide and the optical light guide are coupled, such that bidirectional light from the pump light guide is entirely transferred to the optical light guide.

20. The method according to claim 19, further comprising configuring the pump light guide as a pump light isolator.
